(19) United States
(12) Patent Application Publication
(10) Pub. No.: US 2011/0060841 A1
(43) Pub. Date: Mar. 10, 2011

(54) METHOD AND APPARATUS FOR PROVIDING STREAMING INFORMATION IN A BROADCAST SYSTEM

(75) Inventors: Chang-Dae BANG, Hwaseong-si (KR); Kang-Chun LEE, Suwon-si (KR)

(73) Assignee: Samsung Electronics Co., Ltd., Suwon-si (KR)

(21) Appl. No.: 12/877,664

(22) Filed: Sep. 8, 2010

(30) Foreign Application Priority Data
Sep. 8, 2009 (KR) 10-2009-0084520

(51) Int. Cl. G06F 15/16

(52) U.S. Cl. 709/231

(57) ABSTRACT

A method of providing streaming information in a multimedia broadcast system, includes receiving information of a client connected to a home server; receiving a request from the client and analyzing the received request; and when the received request is a request for streaming information, providing information of a content, which is being streamed in the home server, to the client having sent the request.

### PRIORITY

This application claims priority under 35 U.S.C. §119(a) to an application entitled “Method And Apparatus For Providing Streaming Information In A Broadcast System” filed in the Korean Intellectual Property Office on Sep. 8, 2009 and assigned Serial No. 10-2009-0084520, the contents of which are hereby incorporated by reference.

### BACKGROUND OF THE INVENTION

1. Field of the Invention

The present invention generally relates to a multimedia broadcast system, and more particularly to a method and an apparatus for providing streaming information of another user or another client in a multimedia broadcast system.

2. Description of the Related Art

In general, a multimedia broadcast system providing multimedia data to a plurality of users and a plurality of devices includes a home server for streaming multimedia data and a plurality of clients for receiving multimedia data from the home server. Further, it is possible to construct a multimedia broadcast system according to a Digital Living Network Alliance (DLNA) for digital home networking. In the multimedia broadcast system, a Digital Media Control (DMC) point appoints the location of a Digital Media Server (DMS) and an address of contents stored in the DMS to a Digital Media Renderer (DMR) for reproducing contents, and the DMR can receive a streaming service by making a request for appointed contents to the DMS.

In a general multimedia broadcast system, a home server searches for multimedia information by using meta data information, such as a filename of multimedia data stored for search and reproduction of multimedia in a multimedia content server. Thereafter, the home server provides a list of found contents to clients through a pre-defined transmission protocol, and a client displays the list of found contents through a user interface, such as a display unit. If a content to be reproduced is selected by a user in the next client device, information on the selected content is transferred to the home server according to a pre-defined protocol, and the home server streams the requested content to the client device according to a pre-defined protocol.

Since the conventional multimedia content search and reproduction method of a home server as described above is based on multimedia data stored in a server, it can provide a method of searching for content stored in the server but cannot provide a function capable of searching for or reproducing content or broadcast data, which the server is currently streaming.

Further, since the conventional home server system aims only at distribution of the contents owned by the conventional home server system, it does not manage information on the client device having requested the content. Therefore, the conventional home server system is able to understand neither the client device reproducing the content nor the content reproduced by the client device.

Therefore, when a user wants to reproduce the same content as a multimedia content that is being reproduced in another client device, for example, when a user wants to view a content in his or her own room through a notebook in a state in which the same content is being reproduced by a television in a living room, the user is faced with a cumbersome job of first understanding information of the content, such as a title of the content, searching for the information of the content through a server, etc., and then requesting the server to reproduce the content.

### SUMMARY OF THE INVENTION

Accordingly, the present invention has been made to solve the above-mentioned problems occurring in the prior art, and the present invention provides a method and an apparatus, which can provide a client with streaming information of other users in a multimedia broadcast system for a plurality of users, so that the client can easily obtain information on another client and another user, and the information on the broadcast data or multimedia contents, which another client or another user is reproducing.

In accordance with an aspect of the present invention, there is provided a method of providing streaming information in a multimedia broadcast system, the method including receiving information of a client connected to a home server; receiving a request from the client and analyzing the received request; and when the received request is a request for streaming information, providing information of a content, which is being streamed in the home server, to the client having sent the request.

In accordance with another aspect of the present invention, there is provided a method of receiving streaming information in a multimedia broadcast system, the method including receiving information of a client connected to a home server; receiving a request from the client and analyzing the received request; when the received request is a request for a content, streaming the requested content to the client having sent the request; and storing streaming information on the content, which is being streamed.

In accordance with another aspect of the present invention, there is provided an apparatus for providing streaming information in a multimedia broadcast system, the apparatus including a tuner receiving a plurality of broadcast signals; a broadcast receiving unit selecting channels of the broadcast signals and configuring a channel list and broadcast information; storage units storing multimedia content data; a content search unit securing a list of the storage units and searching for contents of the storage units; a request transmission/reception unit receiving a request from a client; a connection management unit, when receiving a request for a content from the request transmission/reception unit, transferring the requested content to a multimedia transmission unit so that the requested content can be streamed in the client having sent the request, and storing the streaming information in a database; and the multimedia transmission unit receiving multimedia content from the connection management unit and transferring the received multimedia content to a client having requested streaming.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of an apparatus for providing streaming information in a multimedia broadcast system according to an embodiment of the present invention;

FIG. 2 is a flowchart illustrating an operation of providing streaming information in a multimedia broadcast system according to an embodiment of the present invention;

FIG. 3 is a flowchart illustrating a process of receiving information of a client device by a home server at the time of an operation in order to provide streaming information in a multimedia broadcast system according to an embodiment of the present invention;

FIG. 4 is a flowchart illustrating an operation of the request transmission/reception unit in a process of providing streaming information in a multimedia broadcast system according to an embodiment of the present invention;

FIG. 5 is a flowchart illustrating an operation of the connection management unit in a process of providing streaming information in a multimedia broadcast system according to an embodiment of the present invention;

FIG. 6 illustrates an example of a streaming information table stored in a home server in a process of providing streaming information in a multimedia broadcast system according to an embodiment of the present invention;

FIG. 7 is a flowchart illustrating an operation of the remote UI providing unit in a process of providing streaming information in a multimedia broadcast system according to an embodiment of the present invention;

FIG. 8 shows an example of streaming up/down in a process of providing streaming information in a multimedia broadcast system according to an embodiment of the present invention;

FIG. 9 is a block diagram illustrating a state in which streaming is being performed for each client in a multimedia broadcast system according to an embodiment of the present invention; and

FIG. 10 shows an example of a screen providing streaming information in a multimedia broadcast system according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, various specific definitions are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention unclear.

The present invention provides a method and an apparatus, which can provide a client with streaming information of other users in a multimedia broadcast system for a plurality of users, so that the client can easily obtain information on another client and another user, and the information on the broadcast data or multimedia contents, which another client or another user is reproducing. Further, the present invention provides a method and an apparatus, by which a client can easily select a content being streamed in another client and easily streams the selected content.

To this end, according to the present invention, a home server receives information of a client connected to the home server; streams a content upon receiving a request for the content from the client; stores streaming information including information of streamed content, information of the client receiving the streaming, and streaming status information; and provides the streaming information stored in the home server to the client upon receiving a request for the streaming information from the client.

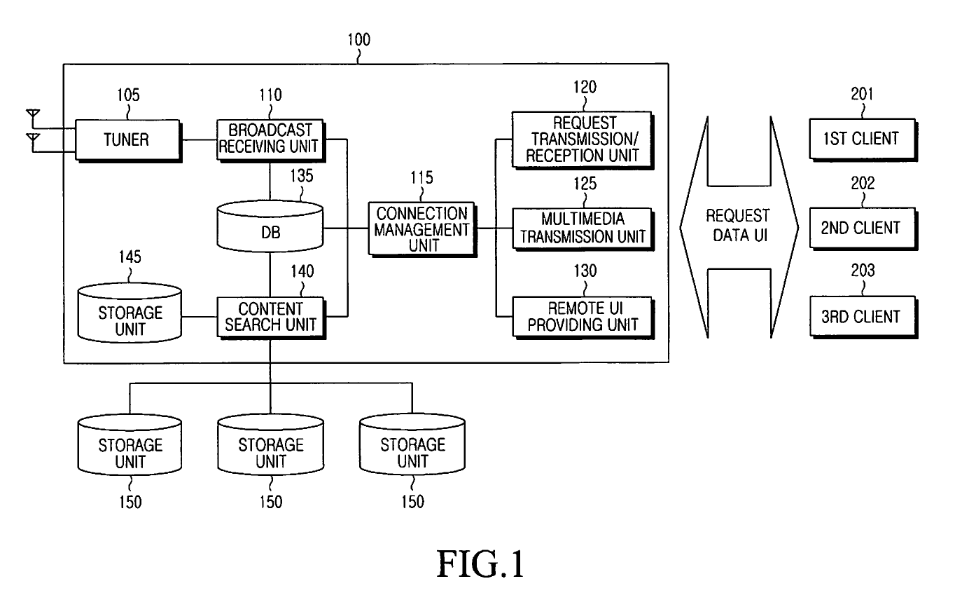

FIG. 1 is a block diagram of an apparatus for providing streaming information in a multimedia broadcast system according to an embodiment of the present invention.

Referring to FIG. 1, a home server apparatus 100 for providing streaming information in a multimedia broadcast system according to an embodiment of the present invention includes a tuner unit 105, a broadcast receiving unit 110, a connection management unit 115, a request transmission/reception unit 120, a multimedia transmission unit 125, a remote User Interface (UI) providing unit 130, a database (DB) 135, a content search unit 140, an internal storage unit 145, and an external storage unit 150.

The tuner unit 105 receives a broadcast signal and may include a plurality of tuners.

The broadcast receiving unit 110 selects a channel with a given frequency, and selects a Physical Transmission Channel according to the Advanced Television Systems Committee (ATSC). The broadcast receiving unit 110 constructs a channel list and broadcast information by analyzing section table data and an Electronic Program Guide (EPG) received through a broadcast signal, and performs registration of the DB 135 and an operation for broadcast reproduction.

The content search unit 140 secures a list of the storage units 145 and 150 connected to the home server apparatus 100, and scans contents of the storage units. Specifically, the content search unit 140 secures a list of connectable storage units 145 and 150 and registers the list in the database 135.

The request transmission/reception unit 120 receives a request from a renderer apparatus connected to the home server apparatus 100 (that is, a client apparatus) or transmits a request to the client apparatus. In the present invention, the request transmission/reception unit 120 performs a network connection upon receiving a connection request from a client apparatus, transfers a title of contents to be streamed and a streaming request to the connection management unit 115 upon receiving the streaming request, and transfers information of the streaming information request to the remote UI providing unit 130 upon receiving the streaming information request indicating a current streaming state.

Upon receiving content information to be streamed from the request transmission/reception unit 120, the connection management unit 115 loads the content information and transfers the loaded content information to the multimedia transmission unit 125. Further, the connection management unit 115 stores information of a client having transmitted the request, which had been transferred from the request transmission/reception unit 120, information of content to be transmitted, and streaming state information in the database 135. If the requested content is real time broadcast content, the connection management unit 115 sends a command to the broadcast receiving unit 110, so as to acquire the requested broadcast content stream and transfer the acquired broadcast content stream to the multimedia transmission unit 125. If the requested content is a multimedia content stored in the internal storage unit 145 or the external storage unit 150, the connection management unit 115 loads the stored multimedia content either internally or through an external network and transfers the multimedia content to the multimedia transmission unit 125.

Further, the connection management unit 115 manages the current streaming state by means of a streaming index list. The connection management unit 115 adds streaming information to the streaming index list when a new streaming starts, and deletes streaming information in the streaming index list when the streaming terminates. Further, detailed contents of the streaming information may be stored in the database 135.

Upon receiving a real time content request from the request transmission/reception unit 120, the connection management unit 115 transfers channel index information included in the request to the broadcast receiving unit 110, and controls the broadcast receiving unit 110 such that the broadcast receiving unit 110 selects a channel using the channel index and provides real time content to the connection management unit 115. Further, the connection management unit 115 transfers the received real time content and client information included in the request to the multimedia transmission unit 125, and controls the multimedia transmission unit 125 such that the multimedia transmission unit 125 streams the real time content to the client.

The multimedia transmission unit 125 streams and/or uploads the multimedia content, which has been transferred from the connection management unit 115, to the client having requested the streaming. Protocols used for the transmission of the multimedia content may include a Hyper Text Transport Protocol (HTTP), Realtime Transport Protocol (RIP), and a User Datagram Protocol (UDP).

Upon receiving a request for streaming information indicating the current streaming state from a client device, the remote UI providing unit 130 constructs a Hyper Text Markup Language (HTML) user interface using the streaming information including reproduction state information, content information, and client information managed by the connection management unit 115, and provides the constructed HTML user interface to the client. At this time, the user interface provided to the client includes information of each client, and information of content and reproduction state information of the content provided to each client. The information in the user interface may be expressed by a thumbnail image or icon, or a simplified sign. Further, the user interface may include a streaming reproduction request, by which a user selects one of contents being streamed to each client and reproduces the selected content in a client of the user, and may include an interface, which enables the selection of a streaming apparatus up/down request and a streaming content up/down request, which enables sequential selection of contents being streamed to each client.

The internal storage unit 145 and the external storage unit 150 store multimedia contents. The internal storage unit 145 is located within the home server 100, and the external storage unit 150 is located outside of the home server 100 and is connected to the home server 100 either directly or through a network.

In the meantime, the home server 100 having the construction as described above can exchange request signals, content data, and UI information, etc. with a plurality of clients 201, 202, and 203, through the request transmission/reception unit 120, the multimedia transmission unit 125, and the remote UI providing unit 130.

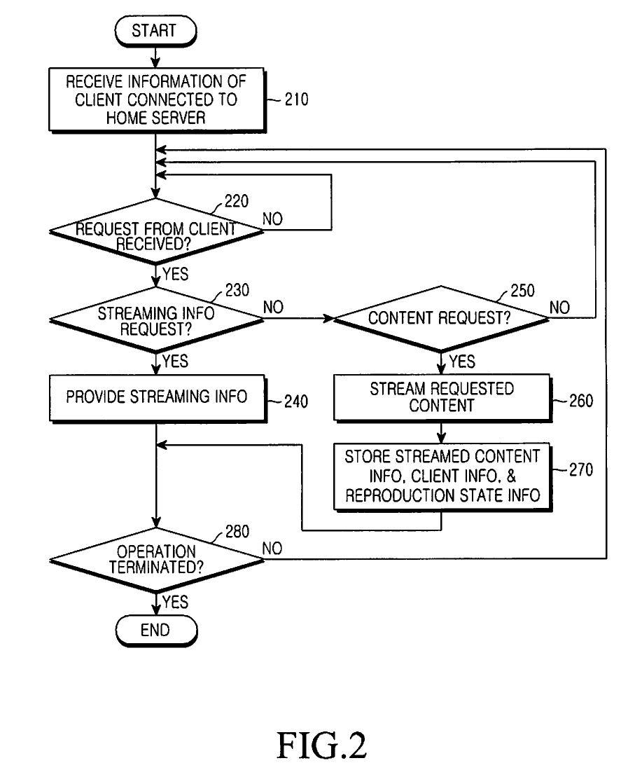

FIG. 2 is a flowchart illustrating an operation of providing streaming information in a multimedia broadcast system according to an embodiment of the present invention.

Referring to FIG. 2 showing the operation of the home server 100 for providing streaming information in a multimedia broadcast system, first in step 210, the home server 100 receives information of the clients 201, 202, and 203 connected to the home server 100. The information of the clients may be received whenever a new client is connected.

Next, in step 220, the home server 100 determines if a request from the clients 201, 202, and 203 has been received. As a result of the determination in step 220, the home server 100 waits when a request has not been received and proceeds to step 230 when a request has been received. In step 230, the home server 100 determines if the received request is a request for streaming information. As a result of the determination in step 230, when the received request is a request for streaming information, the home server 100 proceeds to step 240, in which the home server 100 provides the streaming information to the client having transmitted the request for the streaming information, and then proceeds to step 280. At this time, the streaming information includes information of the content being currently streamed, information of the client receiving the streaming, and information on the streaming state.

As a result of the determination in step 230, when the received request is not a request for streaming information, the home server 100 proceeds to step 250, in which the home server 100 determines if the received request is a request for content. As a result of the determination in step 250, when the received request is not a request for content, the home server 100 returns to step 220. In contrast, when the received request is a request for content as a result of the determination in step 250, the home server 100 proceeds to step 260, in which the home server 100 streams the requested content to the client having transmitted the request for the content. At this time, when the requested content is a broadcast content, the home server 100 transfers the request information to the broadcast receiving unit 110, thereby selecting a channel and streaming the broadcast content. When the requested content is content stored in a storage device, the home server 100 transfers the request information to the broadcast receiving unit 110, thereby searching for corresponding content and streaming the corresponding content. However, in the present invention, the home server 100 may receive a request for a streaming content that is currently being streamed. At this time, the home server 100 may pass information of the client having transmitted the request to the request transmission/reception unit 120, so as to add a streaming object of the multimedia transmission unit 125, so that the multimedia transmission unit 125 can instantly perform the streaming.

Next, in step 270, the home server 100 stores newly streamed content information and streaming information including client information and reproduction state information, thereby updating the streaming information stored in the database 135 of the home server 100.

In step 280, the home server 100 determines if the process has been completed, so as to terminate the process or return to step 220 in order to repeat the process.

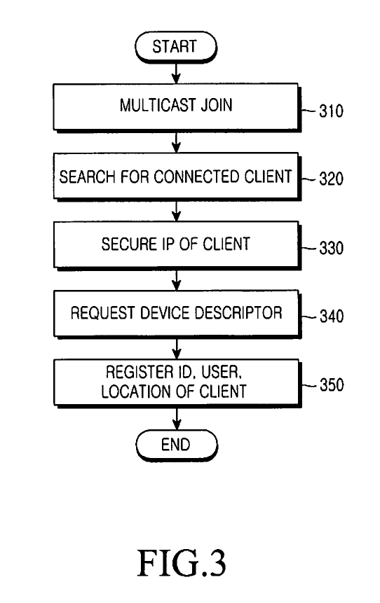

FIG. 3 is a flowchart illustrating a process of receiving information of a client device by a home server at the time of an operation in order to provide streaming information in a multimedia broadcast system according to an embodiment of the present invention. The process shown in FIG. 3 corresponds to step 210 of FIG. 2.

Referring to FIG. 3, first, when a particular client performs a multicast join procedure to the home server 100 in step 310, the home server 100 searches for the newly joined client in step 320. Then, the home server 100 secures an Internet Protocol (IP) address of the client in step 330, and requests a descriptor of the client in step 340. Next, in step 350, the home server 100 registers information of the client, including an identifier (ID), a user, and a location of the client.

According to an embodiment of the present invention, a home server and clients can construct a network by using DLNA or UPnP, and a client can connect to the home server also using the DLNA or Universal Plug ‘n’ Play (UPnP). In the case of UPnP, every apparatus to be controlled has its own Description XML file, which describes itself. Further, the Description XML file is transferred to a UPnP control access point through a UPnP discovery operation as defined in the UPnP spec.

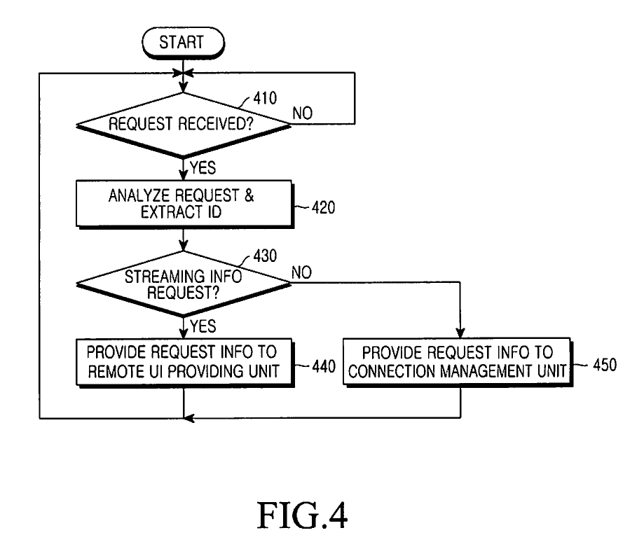

FIG. 4 is a flowchart illustrating an operation of the request transmission/reception unit 120 of FIG. 1 in a process of providing streaming information in a multimedia broadcast system according to an embodiment of the present invention.

Referring to FIG. 4, in step 410, the request transmission/reception unit 120 determines if a request from the clients 201, 202, and 203 has been received. As a result of the determination in step 410, the request transmission/reception unit 120 waits when a request has not been received, and proceeds to step 420 when a request has been received. In step 420, the request transmission/reception unit 120 analyzes the received request and extracts an ID of a client device. Next, in step 430, the request transmission/reception unit 120 determines if the received request is a request for streaming information. As a result of the determination in step 430, when the received request is a request for streaming information, the request transmission/reception unit 120 transfers information on the received request to the remote UI providing unit 130 in step 440, and then returns to step 410, in which the request transmission/reception unit 120 waits for another request. As a result of the determination in step 430, when the received request is not a request for streaming information, the request transmission/reception unit 120 provides the information on the received request to the connection management unit 115 in step 450, and then returns to step 410, in which the request transmission/reception unit 120 waits for another request.

When the home server 100 provides an HTML UI to the clients 201, 202, and 203 like a remote UI, since an HTML script prepared in the home server 100 is transmitted to the clients 201, 202, and 203, the home server 100 can define all request command protocols. If the remote UI is not employed, the clients 201, 202, and 203 can define request commands between the clients 201, 202, and 203 and the home server 100. At the time of providing the request commands, the clients 201, 202, and 203 provide command types, parameters according to the commands, and their own unique IDs.

The commands used in the clients 201, 202, and 203 may include a real time channel setting request for setting a channel of a real time broadcast, a real time recording request for recording a real time broadcast, a real time broadcast reproduction request (real time content request) for reproducing a real time broadcast, a stored content reproduction request for reproducing contents stored in a storage device, a stored content download request for downloading contents stored in a storage device, a streaming information request for acquiring information of contents currently being streamed to another client, a streaming content request for reproducing information of contents currently being streamed to another client, a streaming content up/down request for selecting and reproducing contents currently being streamed by other clients, and a streaming device up/down request for selecting and reproducing contents currently being streamed by other clients.

As used herein, the real time setting request may include a channel index, and the stored content reproduction request may include a Uniform Resource Identifier (URI).

The streaming content up/down request is a command for streaming a previous streaming content or a next streaming content with respect to a currently streamed content including a real time broadcast such as a broadcast channel up/down. This request can set a change order at the time of streaming up/down of contents by sorting the contents.

The streaming device up/down request is a command for receiving a streaming of a content played in a next device or a previous device in the list of devices receiving the streaming. By this request, it is possible to set a change order at the time of streaming up/down of contents by arranging the devices according to the types of the devices. For example, when there exists an audio renderer, such as an MP3 player, and a video renderer, such as a Set-Top Box (STB), a Television, and a Portable Multimedia Player (PMP), the streaming device up/down request may be set to first navigate the contents provided to the devices of the video renderer and then move to and stream the contents provided to the devices of the audio renderer.

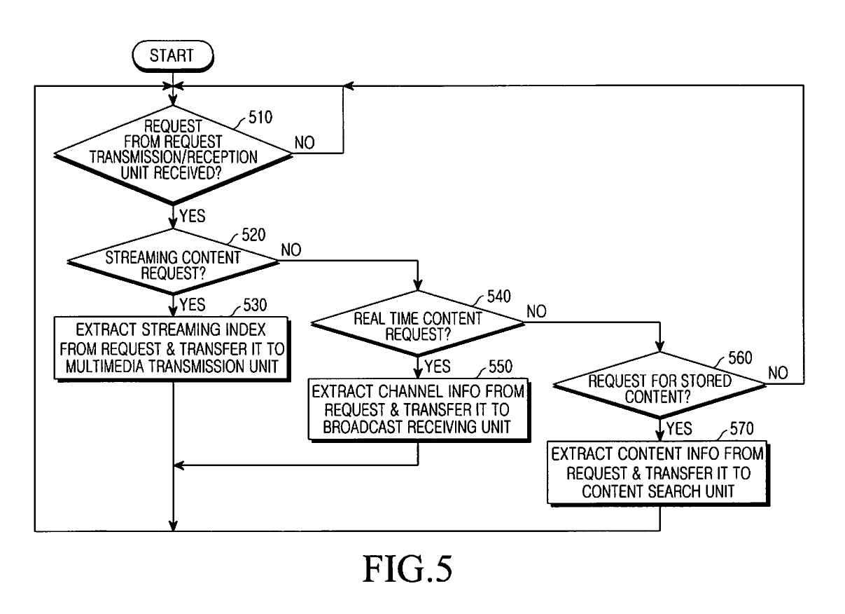

FIG. 5 is a flowchart illustrating an operation of the connection management unit in a process of providing streaming information in a multimedia broadcast system according to an embodiment of the present invention.

Referring to FIG. 5, first in step 510, the connection management unit 115 determines if a command from the request transmission/reception unit 120 has been received. As a result of the determination in step 510, the connection management unit 115 waits when a command has not been received. When a command has been received, the connection management unit 115 proceeds to step 520, in which the connection management unit 115 determines if the received command is a request for streaming content. As a result of the determination in step 520, when the received command is a request for streaming content, the connection management unit 115 proceeds to step 530, in which the connection management unit 115 extracts a streaming index from the requested information and transfers the extracted streaming index to the multimedia transmission unit 125, and then returns to step 510.

When a client has requested a content currently being streamed as described above, it implies that the home server 100 has already acquired content data from a broadcast channel or the storage units 145 and 150, and the home server 100 instantly passes device information of the client to the multimedia transmission unit 125, so that a streaming object of the currently streamed content is added and the streaming is instantly performed. That is, the streaming-requesting client and content information in the requested information is transferred to the multimedia transmission unit, and the requested content information is streamed to the requesting client. As a result, it is possible to instantly perform the streaming without a separate process of content loading or selection.

As a result of the determination in step 520, when the received command is not a request for streaming content, the connection management unit 115 proceeds to step 540, in which the connection management unit 115 determines if the received command is a request for real time content. As a result of the determination in step 540, when the received command is a request for real time content, the connection management unit 115 proceeds to step 550, in which the connection management unit 115 extracts channel information from the requested information and transfers the extracted channel information to the broadcast receiving unit 110, and then returns to step 510.

Upon receiving the request for real time content, the connection management unit 115 transfers channel index information included in the command to the broadcast receiving unit 110, and the broadcast receiving unit 110 acquires requested real time broadcast data by selecting a channel with a given channel index and provides the acquired real time broadcast data to the connection management unit 115. The connection management unit 115 transfers the received real time broadcast data and client information to the multimedia transmission unit 125, so that the real time broadcast is streamed to the client.

As a result of the determination in step 540, when the received command is not a request for real time content, the connection management unit 115 proceeds to step 560, in which the connection management unit 115 determines if the received command is a request for stored content. When the received command is not a request for stored content, the connection management unit 115 returns to step 510. When the received command is a request for stored content, the connection management unit 115 proceeds to step 570, in which the connection management unit 115 extracts content information from the received request for stored content and transfers the extracted content information to the content search unit 140.

Upon receiving the request for stored content, the connection management unit 115 transfers URI information included in the command to the content search unit 140, and the content search unit 140 acquires content data having the requested URI and provides the acquired content data to the connection management unit 115. The connection management unit 115 transfers the received content data together with client information to the multimedia transmission unit 125, so that the multimedia content stored in the client is streamed.

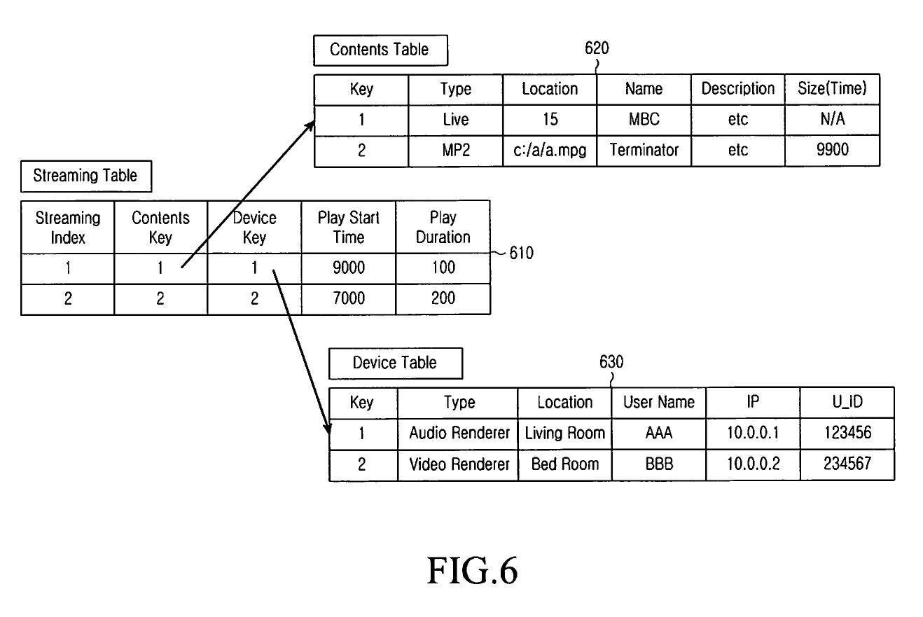

When performing the operation according to the three types of content requests, the connection management unit 115 updates the streaming information, which includes information of the client receiving the streaming, content information, and information of the streaming state at each given time, to the database 135. Hereinafter, a streaming information table as described above will be described with reference to FIG. 6.

FIG. 6 illustrates an example of a streaming information table stored in a home server in a process of providing streaming information in a multimedia broadcast system according to an embodiment of the present invention.

As shown in FIG. 6, the streaming table 610 includes a streaming index, a content key, a device key, a play start time, and a play duration, and each content includes a content table 620 containing content information. The content table 620 includes a key, a type, a location, a name, a description, and a size/time. Further, information of each client device is stored in a client device information table 630, which includes a key, a type, a location, a user name, an IP address, and information of UID.

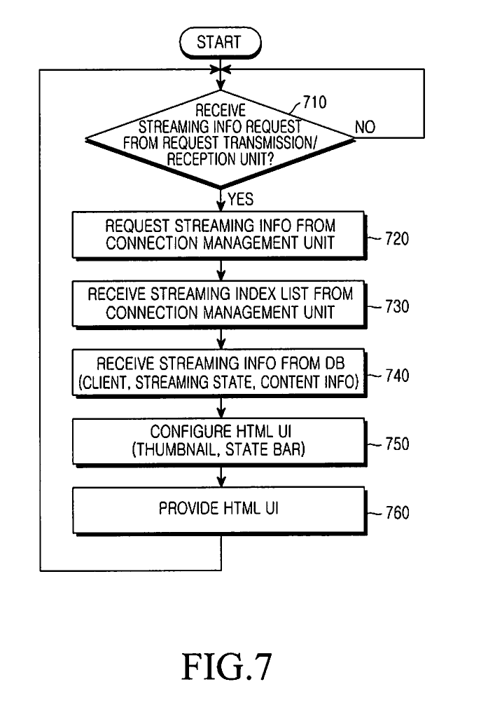

FIG. 7 is a flowchart illustrating an operation of the remote UI providing unit 130 in a process of providing streaming information in a multimedia broadcast system according to an embodiment of the present invention.

First, in step 710, the remote UI providing unit 130 determines if a request for streaming information from the request transmission/reception unit 120 is received. As a result of the determination in step 710, when a request for streaming information is not received, the remote UI providing unit 130 waits. As a result of the determination in step 710, when a request for streaming information is received, the remote UI providing unit 130 proceeds to step 720, in which the remote UI providing unit 130 requests the connection management unit 115 to provide the streaming information. Then, in step 730, the remote UI providing unit 130 receives a streaming index list from the connection management unit 115. In step 740, the remote UI providing unit 130 receives the streaming information included in the streaming index list from the database 135. Next, in step 750, the remote UI providing unit 130 configures an HTML UI. At this time, a broadcast screen can be expressed by a thumbnail, or streaming state information can be expressed by a state bar. Thereafter, in step 760, the remote UI providing unit 130 provides the configured HTML UI to the client requesting the streaming information.

Through the request for streaming information, the real time broadcast content can provide a thumbnail image of a screen, an intrinsic number of a service or channel, program information including a program title, a broadcast time, a broadcast title, and a currently played time. Further, the information of the stored content can provide meta data of the contents, such as a thumbnail image, a total reproduction time, a currently played time, a file name, a file type, genre, and an author. Further, it is possible to provide client device information, such as device type, device name, device location, and device user information.

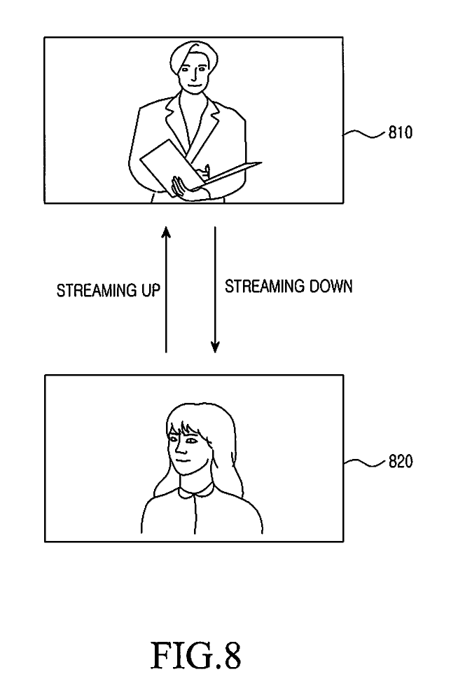

FIG. 8 shows an example of streaming up/down in a process of providing streaming information in a multimedia broadcast system according to an embodiment of the present invention. Referring to FIG. 8, if a movie 810 is being reproduced in a first client and a drama 820 is being reproduced in a second client, a third client can identify, through a request for streaming information, the current reproduction state in the first client and the second client. Then, through streaming contents up/down or streaming device up/down, the third client can easily select and reproduce a content that the third client wants.

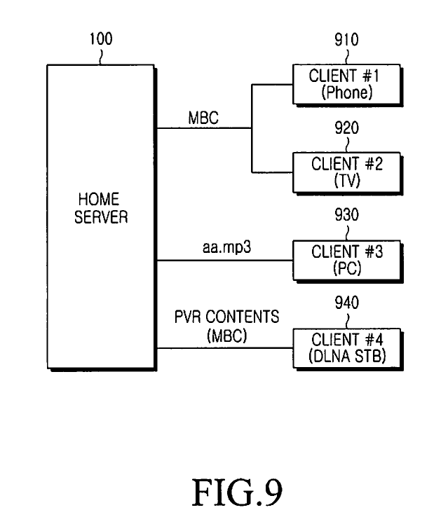

FIG. 9 is a block diagram illustrating a state in which streaming is being performed for each client in a multimedia broadcast system according to an embodiment of the present invention.

Referring to FIG. 9, the first client 910 and the second client 920 are a telephone and a television (TV), respectively, which are reproducing a broadcast of “MBC”, and the third client 930 is a personal computer, which is reproducing stored content named “aa.mp3”. Further, the fourth client 940 is a DLNA STB, which is reproducing a Personal Video Recorder (PVR) content of “MBC”.

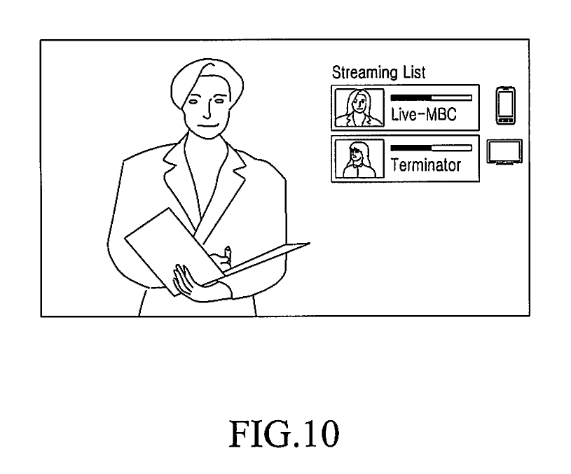

FIG. 10 shows an example of a screen providing streaming information in a multimedia broadcast system according to an embodiment of the present invention. As shown in FIG. 10, in a method of providing streaming information in a multimedia broadcast system, a client can output thumbnail type screens, which are being produced by other clients, on an upper right portion of its own screen, and can display information, such as a title of the content being streamed, elapsed reproduction duration, and the client type, in a manner that enables a user to easily and instantly understand the information.

In a multimedia broadcast system for a plurality of users according to an embodiment of the present invention, information of other users or other clients are provided to a client, and streaming information of other clients is provided to the client, so that the client can easily obtain information of a multimedia content or broadcast, which is being reproduced by other clients or other users.

Therefore, a client can easily obtain information of other clients, information of multimedia contents being viewed by other clients, a reproduction state, and other information by accessing a home server. Further, in the case of using a remote User Interface (UI), a browser installed in the client enables the client to easily use functions provided from the home server.

Further, through the functions, such as the streaming content up/down request and the streaming device up/down request, a client can easily and conveniently reproduce a content, which is being streamed by another client, without a separate loading or search.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of providing streaming information in a multimedia broadcast system, the method comprising the steps of:
receiving information of a client connected to a home server;
receiving a request from the client and analyzing the received request; and
when the received request is a request for streaming information, providing information of content, which is being streamed in the home server, to the client having sent the request.

2. The method of claim 1, wherein the streaming information comprises information of the content, which is being streamed in the home server, information of the client receiving the content, which is being streamed, and streaming state information.

3. The method of claim 2, wherein the information of the content comprises a type of the content, a storage location or channel information, a title, a description, and size or time information.

4. The method of claim 2, wherein the information of the client comprises a type of the client, location of the client, user information, and an Internet Protocol (IP) address.

5. The method of claim 2, wherein the streaming state information comprises a content start time and a total reproduction duration.

6. The method of claim 1, further comprising, when the received request is a request for reproduction of content, which is being streamed in another client, streaming the content, which is being streamed, to the client having sent the request.

7. The method of claim 6, further comprising, when the received request is a request for real time content, streaming real time content according to a channel corresponding to channel information included in the request for the real time content to the client having sent the request.

8. The method of claim 7, further comprising, when the received request is a request for stored content, finding the content through a search using address information of the content included in the request and streaming the found content to the client having sent the request.

9. The method of claim 8, further comprising, when a streaming operation is added in the home server by the received request, storing streaming information of the added streaming operation.

10. The method of claim 2, wherein providing information of content, which is being streamed in the home server, to the client having sent the request comprises constructing a user interface indicating the streaming information and providing the user interface to the client having sent the request by the home server.

11. The method of claim 10, wherein the user interface comprises a thumbnail image of the content, which is being streamed.

12. The method of claim 10, wherein the user interface comprises information of the content, which is being streamed.

13. The method of claim 10, wherein the user interface comprises information of a client receiving the content, which is being streamed.

14. The method of claim 10, wherein the user interface comprises information on a reproduction state of the content, which is being streamed.

15. The method of claim 14, further comprising, when a request for reproduction of the content, which is being streamed in another client, has been received through the user interface, streaming the requested content to the client having sent the request.

16. The method of claim 10, further comprising displaying a means for selecting a request for sequentially selecting contents, which are being streamed, through the user interface.

17. The method of claim 16, wherein the request for sequentially selecting the contents, which are being streamed, is a request for sequentially selecting and reproducing the contents according to A type of the client reproducing the contents, which are being streamed.

18. A method of receiving streaming information in a multimedia broadcast system, the method comprising the steps of:
receiving information of a client connected to a home server;
receiving a request from the client and analyzing the received request;
when the received request is a request for content, streaming the requested content to the client having sent the request; and
storing streaming information on the content, which is being streamed.

19. The method of claim 18, wherein the streaming information comprises information of the content, which is being streamed, information of the client receiving the content, and streaming state information.

20. An apparatus for providing streaming information in a multimedia broadcast system, the apparatus comprising:
a tuner receiving a plurality of broadcast signals;
a broadcast receiving unit selecting channels of the broadcast signals and configuring a channel list and broadcast information;
storage units storing multimedia content data;
a content search unit securing a list of the storage units and searching for contents of the storage units;
a request transmission/reception unit receiving a request from a client;
a connection management unit, when receiving a request for content from the request transmission/reception unit, transferring the requested content to a multimedia transmission unit so that the requested content can be streamed in the client having sent the request, and storing the streaming information in a database; and
the multimedia transmission unit receiving multimedia content from the connection management unit and transferring the received multimedia content to a client having requested streaming.

21. The apparatus of claim 20, wherein the multimedia transmission unit uses a Hyper Text Transport Protocol (HTTP), Realtime Transport Protocol (RTP), OR a User Datagram Protocol (UDP) in transmitting the multimedia content.

22. The apparatus of claim 20, wherein the streaming information comprises information of streamed content, information of a client receiving the content, and streaming state information.

23. The apparatus of claim 22, wherein the information of the content comprises a type of the content, a storage location or channel information, a title, a description, and size or time information.

24. The apparatus of claim 22, wherein the information of the client comprises a type of the client, location of the client, user information, and an Internet Protocol (IP) address.

25. The apparatus of claim 22, wherein the streaming state information comprises a content start time and a total reproduction duration.

26. The apparatus of claim 20, further comprising a remote User Interface (UI) providing unit configuring a user interface by using the streaming information in response to a request from a client, and providing the user interface to the client.

27. The apparatus of claim 26, wherein the request transmission/reception unit analyzes a received request, transfers the received request to the remote UI providing unit when the received request is a request for streaming information, and transfers the received request to the connection management unit when the received request is a request for content.

28. The apparatus of claim 20, wherein the connection management unit receives information of a newly connected client.

29. The apparatus of claim 20, wherein the connection management unit analyzes a request when receiving the request from the request transmission/reception unit, and transfers information of a client and content information, which have been requested to be streamed in the received request, to the multimedia transmission unit when the received request is a request for the content currently being streamed, so that the requested content information is streamed to the client having sent the request.

30. The apparatus of claim 20, wherein the connection management unit analyzes a request when receiving the request from the request transmission/reception unit, and transfers channel information included in the request to the broadcast receiving unit when the received request is a request for real time content, the broadcast receiving unit selects a channel using the channel information and provides real time content corresponding to the channel to the connection management unit under a control of the connection management unit, the connection management unit transfers the real time content and client information included in the received request to the multimedia transmission unit, and the multimedia transmission unit streams the real time content to the client under the control of the connection management unit.

31. The apparatus of claim 20, wherein the connection management unit analyzes a request when receiving the request from the request transmission/reception unit, and transfers Uniform Resource Identifier (URI) information included in the received request when the received request is a request for stored content, the content search unit obtains content data having the requested URI and provides the content data to the connection management unit under a control of the connection management unit, and the connection management unit transfers the received content data together with client information to the multimedia transmission unit, so that the stored multimedia data is streamed to the client having sent the request.

32. The apparatus of claim 26, wherein the remote UI providing unit requests the connection management unit to provide streaming information when receiving a request for the streaming information from the request transmission/reception unit, receives a streaming index list from the connection management unit, receives streaming information included in the streaming index list from the database, and configures a user interface for indicating the received streaming information and provides the user interface to the client having sent the request.

33. The apparatus of claim 32, wherein the user interface configured by using the streaming information comprises information on the streamed content.

34. The apparatus of claim 33, wherein the information on the streamed content comprises a thumbnail image of a screen, an intrinsic number and name of a service or channel, a broadcast duration, a broadcast title, and a currently played time, when the streamed content is real time content, and the information on the streamed content comprises a thumbnail image, a total reproduction duration, a currently played time, a file name, and a file type when the streamed content is stored content.

35. The apparatus of claim 32, wherein the user interface configured by using the streaming information comprises information of a client receiving the content, which is being streamed.

36. The apparatus of claim 35, wherein the information of the client receiving the content, which is being streamed, comprises a device type, a device name, a device location, and device user information of the client.

37. The apparatus of claim 32, wherein the user interface configured by using the streaming information comprises information on a reproduction state of the content, which is being streamed.
